(19) United States
(12) Patent Application Publication
(10) Pub. No.: US 2023/0132464 A1
(43) Pub. Date: May 4, 2023

(54) METHODS AND APPARATUS FOR SUPPORTING COMPARTMENT INSERTS WITH INTERFACE ARRANGEMENTS IN AUTONOMOUS DELIVERY VEHICLES

(71) Applicant: Nuro, Inc., Mountain View, CA (US)

(72) Inventors: Syed Noman Husainie, San Jose, CA (US); Robert Irving Luan, San Jose, CA (US); Je-han Yang, Pasadena, CA (US); Leon Zilun Zhang, Sunnyvale, CA (US)

(21) Appl. No.: 17/901,292

(22) Filed: Sep. 1, 2022

Related U.S. Application Data
(60) Provisional application No. 63/272,914, filed on Oct. 28, 2021.

(51) Int. Cl. B60P 1/64; B60P 7/08

(52) U.S. Cl. CPC B60P 1/649; B60P 1/6436; B60P 7/08; B60P 1/43

(57) ABSTRACT

According to one aspect, a compartment on a vehicle such as an autonomous or semi-autonomous delivery vehicle may be provided with an interface arrangement configured to facilitate the coupling and uncoupling of compartment inserts. The interface arrangement may include mechanical, electrical, and data transmission features. Mechanical features of an interface arrangement may be configured to physically secure or hold a compartment insert in a desired position and/or orientation within a compartment, while electrical features may be configured to enable power to be provided to the compartment insert. Data transmission features may be configured to enable monitoring and control of features of the compartment insert. Different types of compartment inserts may be configured to mate with an interface arrangement, e.g., a substantially universal interface arrangement which effectively provides for interoperability of different compartment inserts, in a compartment of a vehicle.

### CROSS REFERENCE TO RELATED APPLICATION

This application claims priority to U.S. Provisional Application No. 63/272,914, filed Oct. 28, 2021, the entirety of which is incorporated herein by reference.

### TECHNICAL FIELD

The disclosure relates generally to autonomous vehicles. More particularly, the disclosure relates to providing autonomous vehicles with the capability to efficiently deliver a variety of different goods.

### BACKGROUND

As the use of autonomous vehicles increases, the use of autonomous vehicles for different purposes is also increasing. One example of a growing use for autonomous vehicles is the use of autonomous vehicles to provide delivery services. The use of autonomous vehicles to deliver goods to customers may improve the quality of life of the customers, as customers may engage in productive work, entertainment, and/or rest while awaiting the delivery of goods, rather than spend time running errands to procure the goods. Facilitating the efficient delivery of a variety of different goods to customers may further improve the quality of life of the customers.

### BRIEF DESCRIPTION OF THE DRAWINGS

The disclosure will be readily understood by the following detailed description in conjunction with the accompanying drawings in which:

FIG. 1 is a diagrammatic representation of an autonomous vehicle fleet in accordance with an embodiment.

FIG. 2 is a diagrammatic representation of a side of an autonomous vehicle in accordance with an embodiment.

FIG. 3 is a block diagram representation of an autonomous vehicle in accordance with an embodiment.

FIG. 4 is a process flow diagram which illustrates the steps associated with a method of configuring an autonomous vehicle to deliver goods in accordance with an embodiment.

FIG. 5 is a block diagram representation of an overall system which includes an autonomous vehicle and a plurality of compartment inserts that may be placed in compartments of the autonomous vehicle in accordance with an embodiment.

FIGS. 6A-6C are diagrammatic representations of a vehicle and multiple compartment inserts which are configured to be contained in any compartment of the vehicle in accordance with an embodiment.

FIG. 7 is a diagrammatic representation of mechanical and physical connections between an insert interface of compartment of a vehicle and an interface arrangement of a compartment insert in accordance with an embodiment.

FIG. 8 is a process flow diagram which illustrates a method of installing a compartment insert into a compartment which includes an insert interface in accordance with an embodiment.

FIG. 9A is a block diagram representation of a compartment insert in accordance with an embodiment.

FIG. 9B is a block diagram representation of a compartment with an insert interface in accordance with an embodiment.

FIG. 9C is a block diagram representation of a compartment insert interfaced with an insert interface, e.g., compartment insert 950 of FIG. 9A and insert interface 976 of FIG. 9B, in accordance with an embodiment.

FIG. 9D is a block diagram representation of a connector cover as well as a compartment insert interface with an insert interface e.g., compartment insert 950 of FIG. 9A and insert interface 976 of FIG. 9B, in accordance with an embodiment.

FIG. 10 is a block diagram representation of connections associated with a compartment insert and an insert interface of a compartment in accordance with an embodiment.

FIG. 11 is a diagram depicting an installation arrangement by which a person may install a compartment insert into a compartment of a vehicle, according to an example embodiment.

FIG. 12A is a front perspective view of a compartment insert installed into a compartment interface that is mounted to a floor of a compartment of a vehicle, according to an example embodiment.

FIG. 12B shows a bottom perspective view of a compartment insert installed to a compartment interface, according to an example embodiment.

FIG. 13A shows a perspective view of rail member of a compartment insert installed into a track member of a compartment interface, according to an example embodiment.

FIG. 13B shows a side sectional view of a rail member installed into a track member, according to an example embodiment.

FIG. 13C is an enlarged side sectional view of a rear portion of a rail member installed in a track member and further showing a blind match attachment arrangement, according to an example embodiment.

FIG. 14 graphically illustrates a process of installing a compartment insert (having the structure features depicted in FIGS. 12A, 12B, and 13A - 13C into a compartment of a vehicle, according to an example embodiment.

### DESCRIPTION OF EXAMPLE EMBODIMENTS

### General Overview

In one embodiment, a compartment on a vehicle such as an autonomous or semi-autonomous delivery vehicle may be provided with an interface arrangement configured to facilitate the coupling and uncoupling of compartment inserts. The interface arrangement may include mechanical, electrical, and data transmission features. Mechanical features of an interface arrangement may be configured to load, unload, and/or physically secure or hold a compartment insert in a desired position and/or orientation within a compartment, while electrical features may be configured to enable power to be provided to the compartment insert. Data transmission features may be configured to enable monitoring and control of features of the compartment insert. Different types of compartment inserts may be configured to mate with an interface arrangement, e.g., a substantially universal interface arrangement which effectively provides for interoperability of different compartment inserts, in a compartment of a vehicle.

### Detailed Description

Autonomous vehicles may be used to transport wide variety of goods or articles between parties. For example, autonomous delivery vehicles may be used to deliver goods from a retailer to an end consumer or a customer. While some goods do not have specific transport requirements, other goods may have specific transport requirements. By way of example, some goods may need to be maintained within specific temperature ranges to ensure that the goods to reach a destination in a satisfactory state. Other goods may need to be securely held within a compartment to protect against damage such as breakage, e.g, breakage of fragile items, and wrinkling, e.g., wrinkling of clothing which has been dry-cleaned.

Compartment inserts, or modular inserts, which are arranged to be secured or otherwise contained within a compartment of an autonomous vehicle allow for the autonomous vehicle to effectively be specifically configured for a desired purpose. Compartment inserts may be devices that are added to and/or removed from an autonomous vehicle in order to essentially customize a set of capabilities possessed by that vehicle at a specific time. The compartment inserts typically interface with a designed insert interface system on the vehicle which allows for interoperability between multiple types of compartment inserts. The compartment inserts may substantially comply with a modular design template, e.g., “an insert platform.” Compartment inserts may include inserts in a range of shapes and sizes such that one or multiple inserts may be inserted into a single compartment of an autonomous vehicle. In one embodiment, compartment inserts may be independently locked to secure contents contained therein, may draw power from an autonomous vehicle, and may be communicably connected to computers onboard the vehicle in order to be operated and/or controlled remotely.

In one embodiment, an insert interface is configured to facilitate the efficient reconfiguration of a vehicle. Using the insert interface, compartments inserts may be swapped in and out of compartments of a vehicle relatively quickly, thereby enabling a vehicle to be efficiently configured for different purposes. An insert interface in a compartment of a vehicle may include, but is not limited to including, mechanical fasteners which facilitate the insertion and removal of compartment inserts with respect to the compartment and electrical connections which facilitate the ability for power to be provided to compartment inserts by the vehicle. Network communications may be provided with network connections to facilitate the transfer of data between the vehicle and the inserts, and/or between a customer and the inserts. Features on a compartment insert may be configured to substantially engage with corresponding features on the insert interface.

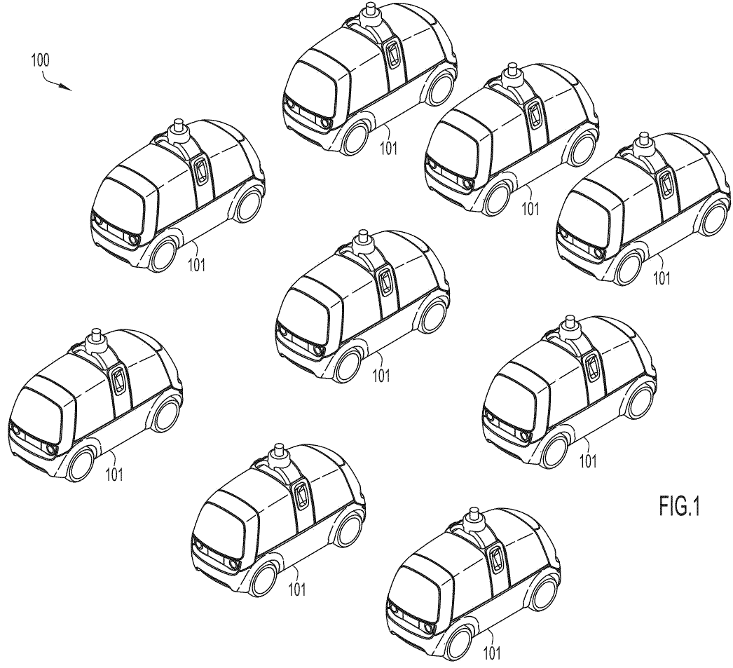

Autonomous vehicles which provide delivery services may generally be included in a fleet of vehicles. Referring initially to FIG. 1, an autonomous vehicle fleet will be described in accordance with an embodiment. An autonomous vehicle fleet 100 includes a plurality of autonomous vehicles 101, or robot vehicles. Autonomous vehicles 101 are generally arranged to transport and/or to deliver cargo, items, and/or goods. Autonomous vehicles 101 may be fully autonomous and/or semi-autonomous vehicles. In general, each autonomous vehicle 101 may be a vehicle that is capable of travelling in a controlled manner for a period of time without intervention, e.g., without human intervention. As will be discussed in more detail below, each autonomous vehicle 101 may include a power system, a propulsion or conveyance system, a navigation module, a control system or controller, a communications system, a processor, and a sensor system.

Dispatching of autonomous vehicles 101 in autonomous vehicle fleet 100 may be coordinated by a fleet management module (not shown). The fleet management module may dispatch autonomous vehicles 101 for purposes of transporting, delivering, and/or retrieving goods or services in an unstructured open environment or a closed environment.

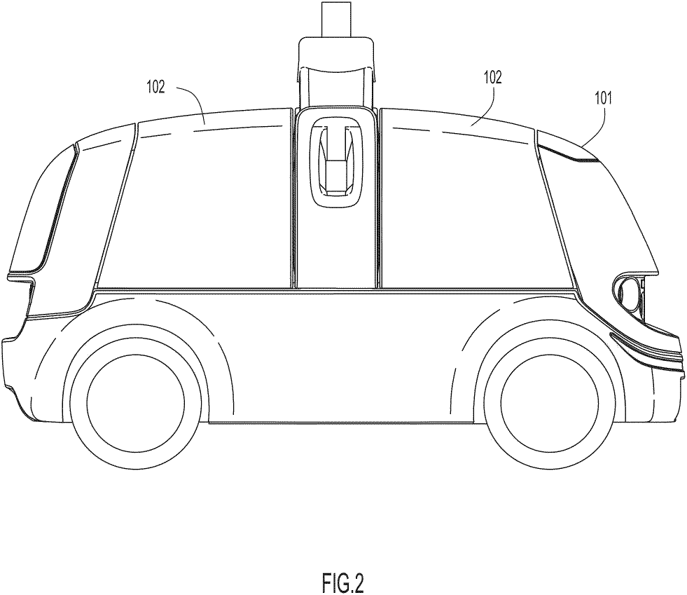

FIG. 2 is a diagrammatic representation of a side of an autonomous vehicle, e.g., one of autonomous vehicles 101 of FIG. 1, in accordance with an embodiment. Autonomous vehicle 101, as shown, is a vehicle configured for land travel. Typically, autonomous vehicle 101 includes physical vehicle components such as a body or a chassis, as well as conveyance mechanisms, e.g., wheels. In one embodiment, autonomous vehicle 101 may be relatively narrow, e.g., approximately two to approximately five feet wide, and may have a relatively low mass and relatively low center of gravity for stability. Autonomous vehicle 101 may be arranged to have a working speed or velocity range of between approximately one and approximately forty-five miles per hour (mph), e.g., approximately twenty-five miles per hour. In some embodiments, autonomous vehicle 101 may have a substantially maximum speed or velocity in range between approximately thirty and approximately ninety mph.

Autonomous vehicle 101 includes a plurality of compartments 102. Compartments 102, or cargo spaces, may be assigned to one or more entities, such as one or more customer, retailers, and/or vendors. Compartments 102 may also be arranged to contain modules or inserts which carry the cargo, items, and/or goods. Typically, compartments 102 may be secure compartments. It should be appreciated that the number of compartments 102 may vary. That is, although two compartments 102 are shown, autonomous vehicle 101 is not limited to including two compartments 102.

In one embodiment, each compartment 102 may be configured to receive one or more compartment inserts (not shown in FIG. 2). Compartment inserts, which will be described in more detail below, are arranged to be inserted into compartments 102 to effectively customize the capabilities provided by autonomous vehicle 101. For example, if autonomous vehicle 101 is used as part of a pizza delivery service, compartment inserts may be warming trays or ovens arranged to keep pizzas warn during delivery. Or, also by way of example, if autonomous vehicle 101 is used as part of a dry-cleaning delivery service, compartment inserts may include a rod on which dry cleaned clothing items on hangers may be hung.

By positioning compartment inserts within compartments of an autonomous vehicle, the autonomous vehicle may relatively efficiently be configured to transport and/or to deliver a particular type of good. That is, the use of various types of compartment inserts which may be inserted into a compartment of a single autonomous vehicle allows the autonomous vehicle to be readily configured to deliver a wide variety of goods. The use of compartment inserts provides the flexibility to use an autonomous delivery vehicle for a variety of different purposes. Further, the use of compartment inserts allows the space within compartments of an autonomous vehicle to be efficiently utilized. By way of example, when deliveries of small items to multiple customers is required, the ability to provide as many compartment inserts designed to contain small items as may fit within a compartment of an autonomous vehicle allows substantially all of the available space within the compartment to be used. As a result, delivery bandwidth of an autonomous vehicle may be substantially maximized. In other words, batching of deliveries enables each autonomous vehicle to carry multiple orders substantially simultaneously.

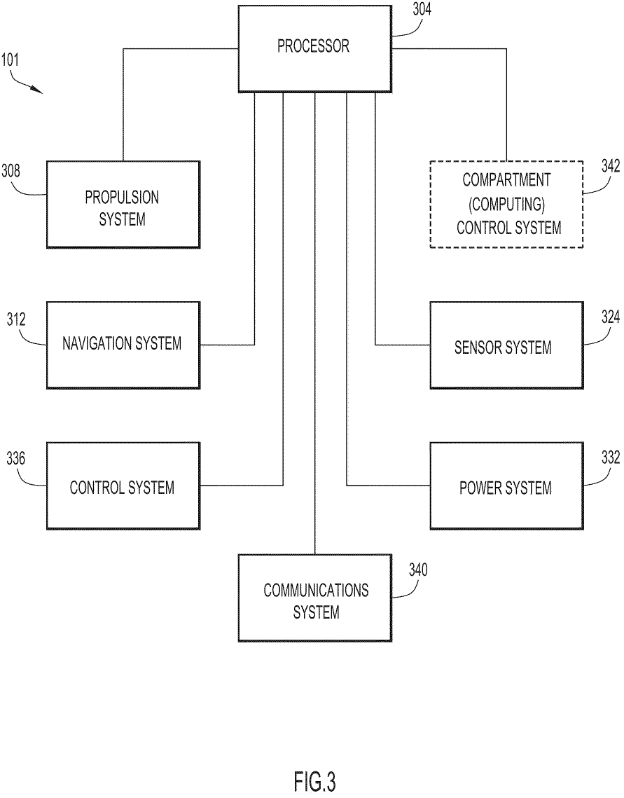

FIG. 3 is a block diagram representation of an autonomous vehicle, e.g., autonomous vehicle 101 of FIG. 1, in accordance with an embodiment. An autonomous vehicle 101 includes a processor 304, a propulsion system 308, a navigation system 312, a sensor system 324, a power system 332, a control system 336, and a communications system 340. It should be appreciated that processor 304, propulsion system 308, navigation system 312, sensor system 324, power system 332, and communications system 340 are all coupled to a chassis or body of autonomous vehicle 101. In one embodiment, vehicle 101 may include an optional compartment control system 342.

Processor 304 is arranged to send instructions to and to receive instructions from or for various components such as propulsion system 308, navigation system 312, sensor system 324, power system 332, and control system 336. Propulsion system 308, or a conveyance system, is arranged to cause autonomous vehicle 101 to move, e.g., drive. For example, when autonomous vehicle 101 is configured with a multi-wheeled automotive configuration as well as steering, braking systems and an engine, propulsion system 308 may be arranged to cause the engine, wheels, steering, and braking systems to cooperate to drive. In general, propulsion system 308 may be configured as a drive system with a propulsion engine, wheels, treads, wings, rotors, blowers, rockets, propellers, brakes, etc. The propulsion engine may be a gas engine, a turbine engine, an electric motor, and/or a hybrid gas and electric engine.

Navigation system 312 may control propulsion system 308 to navigate autonomous vehicle 101 through paths and/or within unstructured open or closed environments. Navigation system 312 may include at least one of digital maps, street view photographs, and a global positioning system (GPS) point. Maps, for example, may be utilized in cooperation with sensors included in sensor system 324 to allow navigation system 312 to cause autonomous vehicle 101 to navigate through an environment.

Sensor system 324 includes any sensors, as for example LiDAR, radar, ultrasonic sensors, microphones, altimeters, and/or cameras. Sensor system 324 generally includes onboard sensors which allow autonomous vehicle 101 to safely navigate, and to ascertain when there are objects near autonomous vehicle. In one embodiment, sensor system 324 may include propulsion systems sensors that monitor drive mechanism performance, drive train performance, and/or power system levels.

Power system 332 is arranged to provide power to autonomous vehicle 101. Power may be provided as electrical power, gas power, or any other suitable power, e.g., solar power or battery power. In one embodiment, power system 332 may include a main power source, and an auxiliary power source that may serve to power various components of autonomous vehicle 101 and/or to generally provide power to autonomous vehicle 101 when the main power source does not include sufficient power. It should be appreciated that power system 332 is arranged to provide power to compartments, e.g., compartments 102 of FIG. 2, or cargo bays such that compartment inserts within the compartments may be powered.

Communications system 340 allows autonomous vehicle 101 to communicate, as for example, wirelessly, with a fleet management system (not shown) that allows autonomous vehicle 101 to be controlled remotely. Communications system 340 generally obtains or receives data, stores the data, and transmits or provides the data to a fleet management system and/or to autonomous vehicles 101 within a fleet 100. The data may include, but is not limited to including, information relating to scheduled requests or orders, information relating to on-demand requests or orders, and/or information relating to a need for autonomous vehicle 101 to reposition itself, e.g., in response to an anticipated demand.

Optional compartment control system 342 may be arranged to communicate with compartments 102 of autonomous vehicle 101, and/or with compartment inserts contained substantially within compartments 102. Such communications may be wireless and or wired communications, e.g., Ethernet communications. Compartment control system 342 may enable compartments 102 and/or compartment inserts to be configured, as for example by causing temperatures within compartments 102 and/or compartment inserts to be set. In one embodiment, compartment control system 342 may control access to, e.g., the opening and/or closing of doors on, compartments 102 and/or compartment inserts, through compartment control system 342, compartments 102 and/or compartment inserts may provide information relating to the compartment inserts. The information provided by compartments 102 and/or compartment inserts may include, but is not limited to including, a type of a compartment insert, a unique identifier (ID) associated with the compartment insert, a condition of the compartment insert, and/or conditions within the compartment insert.

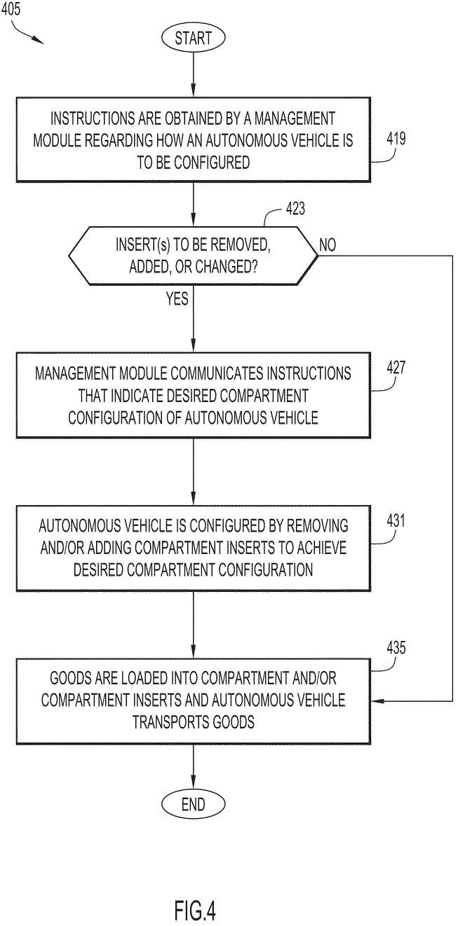

Compartment inserts may be swapped into and out of compartments of autonomous vehicles, in one embodiment, in response to requests from parties that intend to utilize the autonomous vehicles to transport goods. In other words, an autonomous vehicle may be configured based upon the goods that the autonomous vehicle is to transport. Referring next to FIG. 4, the steps associated with a method of configuring an autonomous vehicle to deliver goods in accordance with an embodiment. A method 405 begins at a step 419 in which instructions are obtained regarding how an autonomous vehicle is to be configured. Instructions may be obtained, in one embodiment, by a management module of a fleet management system arranged to manage the autonomous vehicle and other autonomous vehicles. The management module is generally arranged to coordinate the deployment of autonomous vehicles, to assign tasks to the autonomous vehicles, and to monitor the location of each of the autonomous vehicles. The instructions regarding how the autonomous vehicle is to be configured may be associated with an indication of what type of goods the autonomous vehicle is to transport. In one embodiment, the instructions may be received from a retailer that has goods to transport.

From step 419, process flow proceeds to a step 423 in which it is determined whether compartment inserts, if any, that are currently in the autonomous vehicle are to be removed, added, or changed based on the instructions. If the determination in step 423 is that compartment inserts are not to be removed, added, or changed, the implication is that the current configuration of the autonomous vehicle is suitable to accommodate the goods the autonomous vehicle is to transport. Accordingly, process flow moves from step 423 to a step 435 in which goods are located into the compartment of the autonomous vehicle and/or any compartment inserts situated in the compartment, and the autonomous vehicle transports the goods. The method of configuring the autonomous vehicle to transport goods is completed upon the transport of the goods.

Alternatively, if it is determined in step 423 that at least one compartment insert in a compartment of the autonomous vehicle is to be removed, added, or changed, the management module communicates instructions in step 427 which indicate the desired compartment configuration of the autonomous vehicle. The instructions may be communicated using any suitable medium, and to any suitable recipient. For example, instructions may be communicated from the management module to a computing device that allows for the removal and addition of compartments inserts to be automated. In one embodiment, the instructions may be communicated from the management module to a computing device that may be accessed by an individual responsible for coordinating the removal, addition, and changing of compartment modules.

In a step 431, the autonomous vehicle is configured in accordance with the instructions. The autonomous vehicle may be configured by removing and/or adding compartment inserts such that a desired compartment configuration is effectively achieved. In one embodiment, as will be discussed in more detail below, the removing and/or adding of compartment inserts may be facilitated by the use of a substantially universal interface. Once the autonomous vehicle is configured with the desired compartment configurations, goods are loaded into the compartment and/or compartment inserts in step 435. The goods loaded into the compartment and/or compartment inserts are transported by the autonomous vehicle, and the method of configuring the autonomous vehicle to transport goods is completed.

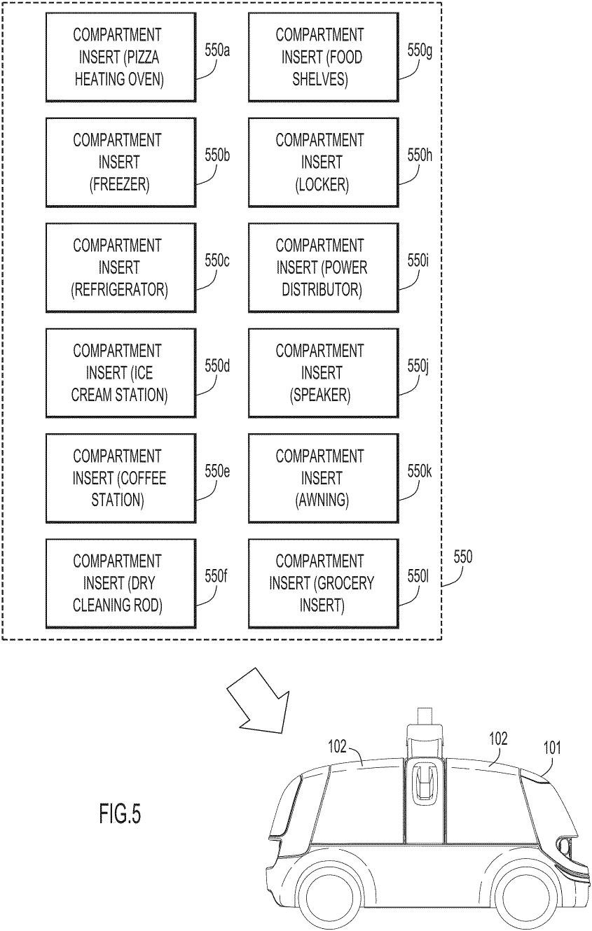

As previously mentioned, compartment inserts which may be used to configure a compartment or a cargo space of an autonomous vehicle may vary widely. With reference to FIG. 5, examples of compartment inserts which may be installed or otherwise placed in a compartment of an autonomous delivery vehicle will be described in accordance with an embodiment. In general, autonomous vehicle 101 may include at least one compartment 102. As shown, autonomous vehicle 101 includes two compartments 102. It should be appreciated, however, that autonomous vehicle 101 may generally include fewer than or more than two compartments 102.

Each compartment 102 is arranged to accommodate one or more compartment inserts 550. Compartment inserts 550 which may be installed in compartments 102 may vary widely in size, shape, and functionality. In general, compartment inserts 550 include a mechanical or physical structure that is configured to contain items and/or to provide a service. Compartment inserts 550 may also be formed from any suitable material, e.g., a thermal insulating material. Compartment inserts 550 may be arranged to draw power from autonomous vehicle 101, e.g., from a power port (not shown) in compartment 102, and may include physical structures such as fasteners that are arranged to allow compartment inserts 550 to be coupled to features within compartment 102 for stability. For example, compartment inserts 550 may be configured to be temporarily mounted to a floor (not shown) of compartment 102. Fasteners, or other features, which allow compartment inserts 550 to effectively be coupled to corresponding features in compartments 102 may include fasteners that enable compartment inserts 550 to be removably coupled to compartments 102 such that compartments inserts 550 may be securely held within compartments 102, while being relatively easy to remove from and insert in compartment 102. The disposition of such fasteners and features enhances the modularity of compartment inserts 550 by allowing compartments inserts 550 to be relatively quick to swap in and out of compartments 102. In one embodiment, compartments 102 may include tracks or guides that features on compartment inserts 550 may slide in and out of such that what while compartment inserts 550 are positioned in compartments 102, such tracks or guides cooperate with the features on compartment inserts 550 to effectively hold compartment inserts 550 in place.

Each compartment insert 550 may have a body, and may include a securable, e.g., lockable, door that is arranged to be unlocked only by an individual, or for an individual, who is authorized to access the contents of compartment insert 550. It should be appreciated that contents of compartment insert 550 may be contained in an interior space of compartment insert 550, e.g., a space that is defined by or within the body. Such a lockable door may be transparent, or may include a transparent feature, which allows contents of compartment insert 550 to be viewed. In some embodiments, two or more compartment inserts 550 may be arranged to be coupled to each other for additional stability. It should be appreciated that each compartment insert 550 may be substantially divided into one or more sections, each of which may include a separate securable door or covering.

Compartment inserts 550 may include a compartment insert 550a that is a pizza heating oven that is arranged to keep a pizza contained within compartment insert 550a warm while the pizza is transported by autonomous vehicle 101. Compartment insert 550a may include at least one heating element, e.g., a heating coil, which allows a pizza within compartment insert 550a to be kept warm. Compartment insert 550a may have a body that includes walls which define a space within the body that is heated by at least one heating element. The heating element is provided within compartment insert 550a, and may be powered using power provided by autonomous vehicle 101. Compartment insert 550a may also include a rack or a shelf on which a pizza, e.g., a pizza packaged within a pizza delivery box, may be placed. In one embodiment, compartment insert 550a may include a red color marking and/or a warning label that provides an indication that the contents of compartment insert 550a are hot.

Some compartments inserts 550 may provide cooling capabilities. For example, a compartment insert 550b may be a freezer insert and a compartment insert 550c may be a refrigerator insert. Compartment insert 550b may be maintained at a temperature which is sufficient to allow contents to remain in a frozen state, while compartment insert 550c may be maintained at a temperature which is sufficient to allow contents to remain cool. Compartment inserts 550b, 550c may include compressors, pipes, and refrigerant gases that are provided with power from autonomous vehicle 101 . In one embodiment, compartment insert 550b and compartment insert 550c may include blue color markings and/or warning labels that provide indications that the contents of compartment insert 550b are frozen and that the contents of compartment insert 550c are cool or cold.

Compartment inserts 550 may be specialized and configured to provide the experience of being at a store or a kiosk. For example, a compartment insert 550d may be an ice cream station and a compartment insert 550e may be a coffee station. Compartment insert 550d may include freezer capabilities such that ice cream or other frozen desserts may be kept frozen. Compartment insert 550d may include an ice cream dispenser and other features, e.g., a toppings tray or an ice cream cone dispenser, such that autonomous vehicle may have substantially the same functionality as an ice cream truck. Compartment insert 550e may include a coffee maker, a water reservoir arranged to supply water to the coffee maker, and other features, e.g., a cup dispenser and a milk dispenser, which effectively enable compartment insert 550e to serve as a coffee station.

Compartment inserts 550 may include a compartment insert 550f that supports a dry-cleaning delivery service, e.g., by providing a rod which extends substantially horizontally between side walls of compartment insert 550f. Compartment insert 550f may include a rod on which dry cleaned clothing, which is typically presented on a hanger, may be hung,

In one embodiment, compartment inserts 550 may include a compartment insert 550g which is configured with shelves on which items may be stored and/or displayed. For example, compartment insert 550g may include shelves such that grab-and-go sandwiches may be displayed on the shelves. Compartment insert 550g may be arranged to provide cooling capabilities such that displayed items may remain cooled during transport. Alternatively, compartment insert 550g may be arranged to provide heating capabilities such that displayed items may remain heated during transport.

Compartment inserts 550 may also generally include a compartment insert 550f which serves as a locker. Compartment insert 550h may be configured as a substantially empty box, or may be configured to include shelves, hooks, pouches, and/or other mechanisms arranged to support goods within compartment insert 550h. As is the case for other compartment inserts 550, compartment insert 550h may be lockable. In one embodiment, compartment insert 550h may include multiple lockers that may be individually locked, e.g., compartment insert 550h may include two or more subcompartments which may be substantially independently locked and/or controlled.

Some compartment inserts 550 may be arranged to facilitate the use of other compartment inserts 550. For example, a compartment insert 550i may be a power distributor. In one embodiment, compartment insert 550i may be arranged to obtain power from autonomous vehicle 101, and may include power ports that other compartment inserts 550 may plug into, e.g., when compartment 102 does not include enough power ports to support compartment inserts 550 contained within compartment 102. Compartment insert 550i may instead, in some instances, include power ports that are powered by a battery included in compartment insert 550i.

Compartment inserts 550 may also include a compartment insert 550j that includes a speaker. Compartment insert 550j may be arranged to broadcast information or entertainment, for example, to customers or other individuals who are located in an environment around autonomous vehicle 101. For instance, compartment insert 550j may broadcast an alert that autonomous vehicle is arriving at a location, or may broadcast an alert that autonomous vehicle is about to depart a current location.

In the described embodiment, compartment inserts 550 may include a compartment insert 550k that is configured to provide protection from weather conditions. For example, compartment insert 550k may be arranged to enable an awning or an umbrella to be deployed such that a user of vehicle 101 may be protected from rain by the awning or the umbrella. Compartment insert 550k may generally include a covering and a deployment mechanism. The covering may be configured to shield a user and/or goods within compartments 102 upon deployment.

Compartment inserts 550 may include grocery insert 5501 that is configured to provide a board on which grocery items, e.g., cans and boxes, may be positioned or, in one embodiment, effectively displayed. Grocery insert 5501 may include raised areas and/or grooves which facilitate the positioning of grocery items on or within grocery insert 5501. Grocery insert 5501 may include an onboard power source, and/or may include power ports.

To facilitate the configuration and reconfiguration of a vehicle such as vehicle 101, compartments of the vehicle may each include an interface which is substantially universal, e.g., configured to support a variety of different compartment inserts. That is, compartments of a vehicle may be provided with insert or coupling interfaces which enable compartment inserts to be readily positioned in and removed from the compartments. Such insert or coupling interfaces may include mechanical fastening arrangements arranged to effectively lock compartment inserts into place, power connections arranged to provide power to compartment inserts, and/or network connections arranged to provide network connectivity to compartment inserts. The compartment inserts may be configured to connect to, or to otherwise interface with, the insert or coupling interfaces.

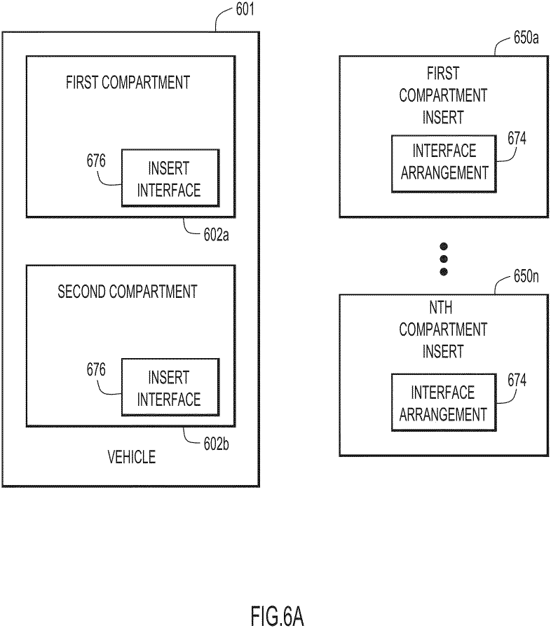

FIGS. 6A-6C are diagrammatic representations of a vehicle and multiple compartment inserts which are configured to be contained in substantially any compartment of the vehicle in accordance with an embodiment. As shown in FIG. 6A, vehicle 601 includes at least a first compartment 602a and a second compartment 602b. Multiple compartment inserts 650a, 650n may be arranged to be installed in compartments 602a, 602b. In one embodiment, compartment inserts 650a, 650n have different functionalities or capabilities.

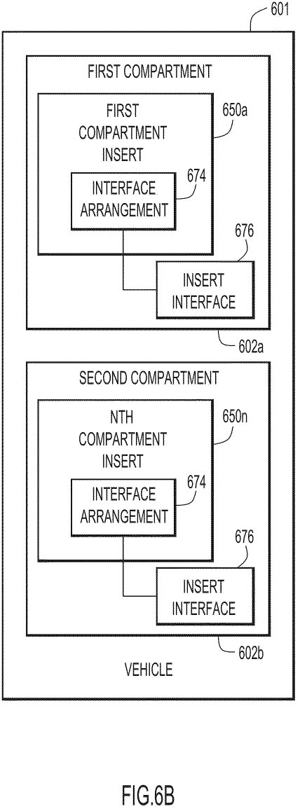

First compartment 602a and second compartment 602b each include an insert or coupling interface 676. Typically, insert interfaces 676 are positioned on surfaces of compartments 602a, 602b. Insert interface 676, which will be discussed in more detail below with respect to FIG. 7, is configured to enable compartment inserts 650a, 650n to be physically installed in compartments 602a, 602b and, in some embodiments, enables compartment inserts 650a, 650n to communicate with vehicle 601.

First compartment insert 650a and nth compartment insert 650n each include an interface arrangement 674 that is configured to be physically coupled to insert interface 676. Interface arrangement 674, which will be discussed in more detail below with respect to FIG. 7, is configured to effectively mate with insert interface 676. Typically, compartment inserts 650a, 650n have external surfaces, e.g., external surfaces of bodies or shells of compartment inserts 650a, 650n, on which interface arrangements 674 are at least partially supported.

Because compartments 602a, 602b each include insert interface 676 which is arranged to mate with, or to otherwise interface with or connect to, interface arrangement 674 of compartment inserts 650a, 650n, compartment inserts 650a, 650n may be readily installed in either compartment 602a, 602b. While insert interface 676 may generally be positioned substantially anywhere within compartments 602a, 602b, insert interface 676 is typically positioned on a floor of compartments 602a, 602b. As shown in FIG. 6B, first compartment insert 650a may be installed in first compartment 602a, and nth compartment insert 650n may be installed in second compartment 602b. Interface arrangement 674 of first compartment insert 650a is coupled to insert interface 676 of first compartment 602a, and interface arrangement 674 of second compartment insert 650n is coupled to insert interface 676 of second compartment 602b.

As interface arrangement 674 is substantially the same in compartment inserts 650a, 650n, and insert interface 676 is substantially the same in compartments 602a, 602b, compartment insert 650a may instead be installed in second compartment 602b, and compartment insert 650n may instead be installed in first compartment 602a, as shown in FIG. 6C. Interface arrangement 674 of first compartment insert 650a is coupled to insert interface 676 of second compartment 602b, and interface arrangement 674 of first compartment insert 650a is coupled to insert interface 676 of second compartment 602b

Interface arrangement 674 and insert interface 676 may be configured to include a variety of different coupling mechanisms and/or interfaces, and generally cooperate to provide connections between compartment inserts 650a, 650n and compartments 602a, 602b. FIG. 7 is a diagrammatic representation of connections included in insert interface 676 and included in interface arrangement 674 accordance with an embodiment.

In one embodiment, insert interface 676 includes a mechanical coupling 776a, a power/electrical port 776b, a communications port 776c, and an installation detection interface 776d, while interface arrangement 674 includes an optional mechanical coupling 774a, an optional power/electrical coupling 774b, an optional communications coupling 774c, and an optional installation detection coupling 774d. It should be appreciated that interface arrangement 674 generally includes at least one coupling 774a-d. In one embodiment, interface arrangement 674 includes mechanical coupling 774a, power/electrical coupling 774b, communications coupling 774c, and installation detection coupling 774d. Interface arrangement 674 and insert interface 676 may be arranged to be physically coupled together.

Mechanical coupling 776a is configured to couple to optional mechanical coupling 774a to for a substantially physical, or mechanical connection. In one embodiment, mechanical coupling 776a may be a mechanical fastener that is configured to engage mechanical coupling 774a to securely hold a compartment insert within a compartment of a vehicle. In another embodiment, mechanical coupling 774a may be an exterior of a compartment insert and arranged to engage mechanical coupling 776a, which may be a feature within a compartment.

Power/electrical port 776b is configured to provide power to an optional power/electrical coupling 774b. It should be appreciated that in some embodiments, such as embodiments in which a compartment insert includes a dedicated power source such as a battery or does not need power, power/electrical coupling 774b may either not be part of a compartment insert or may be embodied as a ground connection. Through power/electrical coupling 774b, power may be obtained via power/electrical port 776b.

Communications port 776c may be any suitable port that supports communications, as for example Ethernet communications. Optional communications coupling 774c may enable communications signals to be sent and received by a compartment insert. For example, through a connection between communications port 776c and communications coupling 774c, a vehicle may control a compartment insert and the compartment insert may provide status updates to the vehicle. In one embodiment, communications coupling 774c may be utilized to enable a compartment insert to communicate with a customer.

Installation detection interface 776d is configured to detect when a compartment insert has been installed in a compartment. Optional installation detection coupling 774d, which may include an electrical pin, may come into contact with installation detection interface 776d to effectively signal that a compartment insert has been installed. When installation detection coupling 774d engages with installation detection interface 776d, a compartment control system of a vehicle may determine that an installation of a compartment insert has occurred, and may effectively initiate a determination of whether the compartment insert is smart, as described above. In one embodiment, installation detection coupling 774d may be an electrical pin, and installation detection interface 776d may include a socket, e.g., an electrical socket, which is configured to receive the electrical pin.

In one embodiment, when interface arrangement 674 does not include substantially all couplings 774a-d, couplings 774a-d that are effectively not live or not in use may be grounded or otherwise connected to ground. When interface arrangement 674 has a particular footprint, or configuration of couplings 774a-d, false couplings or otherwise non-functional couplings may be included in interface arrangement 674 as a physical substitute for couplings 774a-d which are not included.

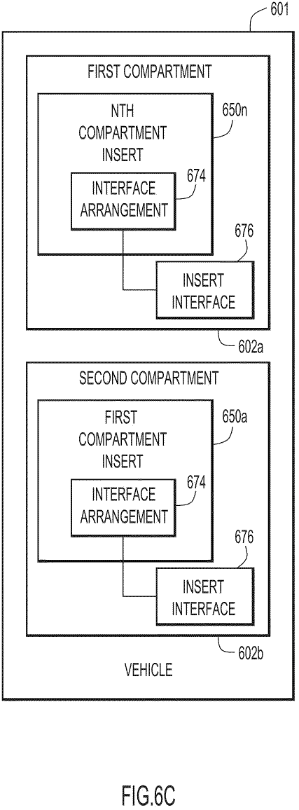

FIG. 8 is a process flow diagram which illustrates a method of installing a compartment insert into a compartment of a vehicle which includes an insert interface in accordance with an embodiment. A method 805 of installing a compartment insert into a compartment which includes an insert interface begins at a step 809 in which a compartment insert is obtained and guided into position within a compartment using one or more insert tracks included in an insert interface of the compartment. An insert track, e.g., a guide rail, may be recessed in a floor of the compartment, and may receive a feature of a compartment insert such as a foot or a wheel to effectively facilitate the alignment or positioning of the compartment insert within the compartment. It should be appreciated that while one or more insert tracks may be used to facilitate the installation of a compartment insert, other mechanisms may be used in addition to or in lieu of using insert tracks.

Once the compartment insert is guided, e.g., slid or rolled, into position within the compartment, the compartment insert may be mechanically or physically coupled to the insert interface using one or more blind mate attachments in a step 813. That is, the compartment insert is effectively coupled with, e.g., latched to, one or more features in the compartment using only the compartment insert and the insert interface of the compartment. As will be understood by those skilled in the art, the use of a blind mate attachment, e.g., connector, may support a connection action that causes physical mating substantially using only the components which are to be mated. The connection action may generally involve sliding a feature of the compartment insert into a feature of the insert interface and/or snapping a feature of the compartment insert into a feature of the insert interface. In addition, guiding the compartment insert into position within the compartment is not limited to being slid into position. By way of example, guiding the compartment insert may alternatively, or additionally, include tilting, wedging, dropping, raising, and/or other suitable motions that may effectively guide the compartment insert into and within a compartment. To achieve guiding, motion may be provided by, but is not limited to being provided by, tools, actuators, and/or external installation systems.

From step 813, process flow proceeds to an optional step 817 in which the compartment insert is electrically coupled to the insert interface using one or more electrical connectors. An electrical connector of the insert interface is recessed into a floor of a compartment, and may be secured with respect to the floor of the compartment. An electrical connector of the compartment insert may effectively be mated with the electrical connector of the insert interface. The location of the electrical connector of the insert interface may be arranged to facilitate connecting the insert interface and the compartment insert. Similarly, the location of the electrical connector of the compartment insert may be such that an electrical connection between the compartment insert and the insert interface may be readily accomplished. In one embodiment, the electrical connector may be embodied as a harness that facilitates a connection between the compartment insert and power, e.g., DC power.

In an optional step 821, the compartment insert is communicably coupled to the insert interface using one or more network, e.g., Ethernet, connectors. The location of network connectors on a compartment insert and/or an insert interface may be selected to facilitate the network connection between the compartment insert and the insert interface. In one embodiment, a network interface may be included as part of an electrical connector. In such an embodiment, electrically coupling the compartment insert to the insert interface may also effectively communicably coupled the insert interface to the insert interface.

The compartment insert is mechanically coupled to the insert interface in a step 825 using supplemental or additional insert attachments. By way of example, the insert attachments may be features which are arranged to be screwed and/or bolted into the insert interface. The insert attachments may effectively cooperate with the blind mate attachments to relatively securely engage the compartment insert to the insert interface. In one embodiment, the blind mate attachments may be located towards the back of the compartment and the insert attachments may be located towards the front of the compartment. The insert attachments, which may be located on the compartment insert, may enable the compartment insert to be fastened to the insert interface. Such insert attachments may provide additional structural security with respect to maintaining the compartment insert in a desired position within the compartment.

After the supplemental or additional insert attachments are used to mechanically couple the compartment insert to the insert interface, a connector cover is installed in a step 829. A connector cover may be installed to effectively cover the additional insert attachments and/or any electrical or network connectors. By covering the additional insert attachments and/or any electrical or network connectors, customers retrieving items from or loading items into a compartment may be substantially prevented from tampering with and accessing the additional insert attachments and/or electrical or network connectors. In one embodiment, fasteners used to secure the connector cover in place may be configured such that the fasteners are relatively difficult to disengage, as for example without the use of specialized tools that a customer may not have access to. Upon installing the connector cover, the method of installing a compartment insert into a compartment which includes an insert interface is completed.

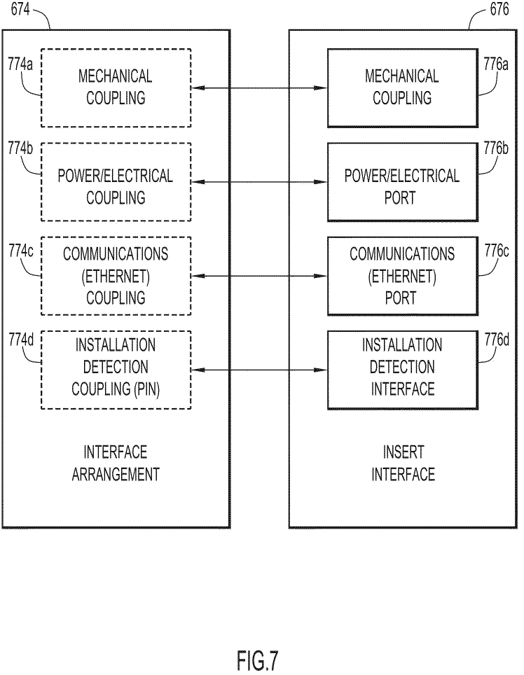

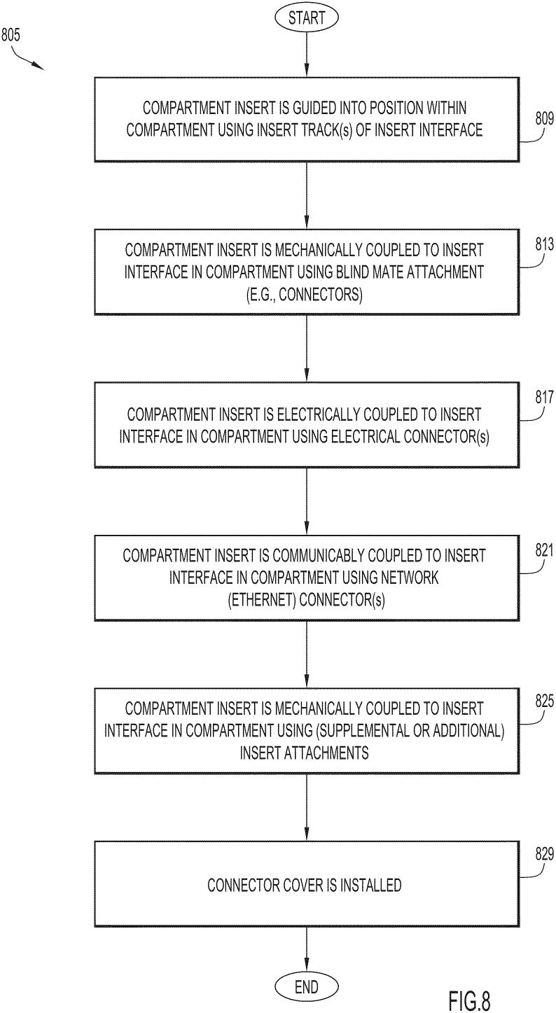

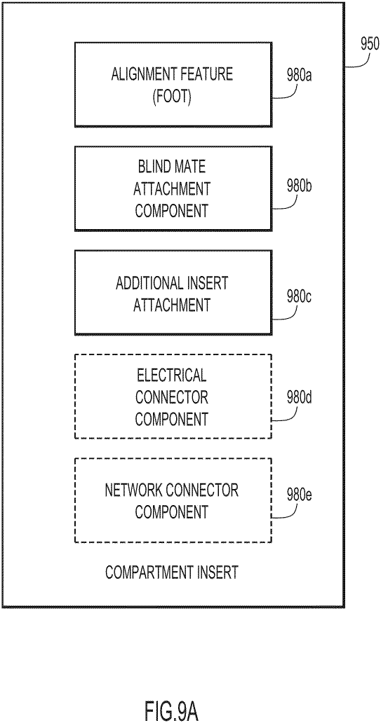

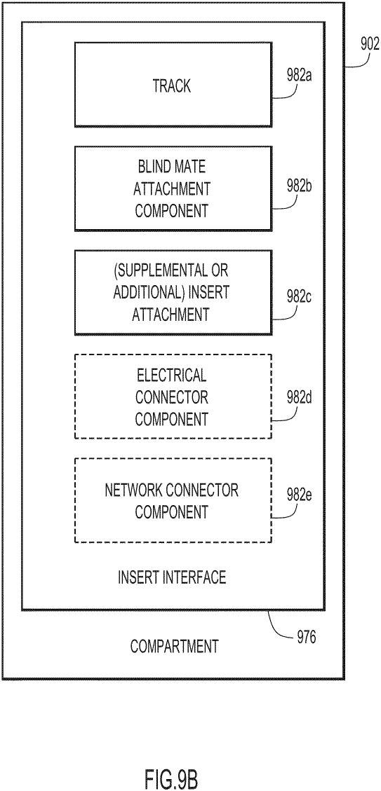

With respect to FIGS. 9A-9D, components associated with an overall platform which enables compartment inserts to be loaded into compartments with insert interfaces as discussed with respect to FIG. 8 will be described. FIG. 9A is a block diagram representation of a compartment insert in accordance with an embodiment. A compartment insert 950, which is arranged to be loaded into a compartment of a vehicle and may generally be configured to carry goods and/or to provide services, includes an alignment feature 980a, a blind mate attachment or connector component 980b, a supplemental or additional insert attachment 980c, an optional electrical connector component 980d, and an optional network connector component 980e.

Alignment feature 980a, which may be a foot or other protrusion on compartment insert 950, is generally arranged to facilitate the positioning of compartment insert 950 within a compartment. Blind mate attachment or connector component 980b may be a component that is arranged to engage a blind mate attachment component of an insert interface of a compartment such that compartment insert 950 may essentially be held in a desired position when loaded into the compartment. In one embodiment, blind mate attachment component 980b may be positioned towards a back end of compartment insert 950. Insert attachment 980c is a portion of compartment insert 950 that is configured to be attached or fastened to an insert interface. Insert attachment 980c may be a mechanical attachment that provides additional physical coupling of compartment insert 950 within a compartment, e.g., additional physical coupling with respect to blind mate attachment component 980b. Optional electrical connector component 980d and optional network connector component 980e are configured to enable compartment insert 950 to draw power and to enable compartment insert 950 to engage in network communications, respectively.

FIG. 9B is a block diagram representation of a compartment with an insert interface in accordance with an embodiment. A compartment 902 may generally be a compartment onboard a vehicle such as an autonomous vehicle. Compartment 902 includes an insert interface 976 which is configured to engage a compartment insert, e.g., compartment insert 950 of FIG. 9A, as will be discussed below with reference to FIG. 9C. In one embodiment, insert interface 976 may be recessed within a floor of compartment 902.

Insert interface 976 includes a track 982a, a blind mate attachment component 982b, an insert attachment 982c, an optional electrical connector component 982d, and an optional network connector component 982e. Track 982a is configured to enable a compartment insert such as compartment insert 950 of FIG. 9A to be guided within compartment 902 into a position that enables blind mate attachment component 982b to engage blind mate attachment component 980b of compartment insert 950. Insert attachment 982c is configured to enable a compartment insert such as compartment insert 950 of FIG. 9A to be further attached or physically engaged with compartment 902. Optional electrical connector component 980d and optional network connector component 980e are configured to enable compartment 902 to provide power and to engage in communications such as network communications with a compartment insert such as compartment insert 950 of FIG. 9A, respectively.

FIG. 9C is a block diagram representation of compartment insert 950 of FIG. 9A interfacing with insert interface 976 of FIG. 9B in accordance with an embodiment. When compartment insert 950 is inserted within compartment 902, features of compartment insert 950 effectively engage with corresponding features of insert interface 976.

Alignment feature 980a may be positioned within track 982a and moved within track 982a until alignment feature 980a is at a location which effectively enables blind mate attachment component 980b to engage with blind mate attachment component 982b. In one embodiment, blind mate attachment components 980b, 982b may engage when blind mate attachment component 980b effectively latches into blind mate attachment component 982b. The engagement of blind mate attachment components 980b, 982b effectively holds compartment insert 950 in a substantially desired position within compartment 902.

Insert attachment 980c and insert attachment 982c may be engaged to further secure compartment insert 950 within compartment 902. Insert attachment 980c may be a mechanical structure or feature which may be connected to insert attachment 982c. By way of example, insert attachment 980c may be plate with an opening, and insert attachment 982c may include a receptacle that may be substantially coupled to insert attachment 980c using a fastener such as a screw or a bolt.

Optional electrical connector components 980d, 982d may engage with each other such that electricity and/or power may be provided to electrical connector component 980d by compartment 902, or by a vehicle on which compartment 902 is carried, Optional network connector components 980e, 982e may engage with each other such that data may be exchanged between compartment insert 950 and compartment 902, or by a vehicle on which compartment 902 is carried.

As shown in FIG. 9D, in one embodiment, a connector cover 984 may effectively be coupled to both compartment insert 950 and compartment 902. Connector cover 984 may be arranged such that, when coupled to compartment insert 950 and compartment 902, insert attachments 980c, 982c as well as optional electrical connector components 980d, 982d and optional network connector components 980e, 982e, are effectively covered. That is, connector cover 984 may be arranged to substantially prevent tampering with respect to insert attachment 980c, insert attachment 982c, optional electrical connector component 980d, optional electrical connector component 982d, optional network connector component 980e, and optional network connector component 982e.

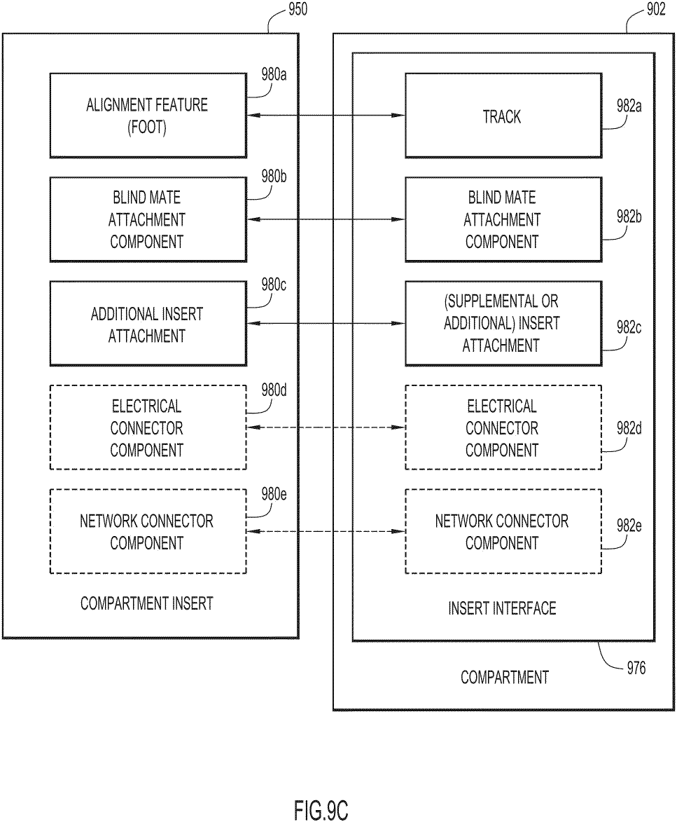

FIG. 10 is a block diagram representation of connections associated with a compartment insert and an insert interface of a compartment tin accordance with an embodiment. A compartment insert 1050, which may be arranged to carry goods, is configured to interface with an insert interface 1076 in a compartment 1002 of a vehicle includes an alignment feature 1080a and a first connector component 1080b. Compartment insert 1050 also includes an optional second connector component 1080c, an optional electrical connector component 1080d, and an optional network connector component 1080e. Insert interface 1076 is configured to engage compartment insert 1050, and includes an alignment arrangement 1082a, a first connector component 1082b, an optional second connector component 1082c, an optional electrical connector component 1082d, and an optional network connector component 1082e.

Alignment feature 1080a is generally configured to cooperate with alignment arrangement 1082a to enable compartment insert 1050 to be positioned within compartment 1002 in a desired position and/or orientation. By way of example, alignment feature 1080a may be guided by alignment arrangement 1082a to place compartment insert 1050 into a desired position and/or orientation.

First connector component 1080b cooperates with first connector component 1082b to effectively engage compartment insert 1050 within compartment 1002 when compartment insert 1050 is in a desired position and/or orientation. First connector component 1080b and first connector component 1082b may essentially be configured to mate or to otherwise connect. In one embodiment, first connector component 1082b may be substantially universal, or otherwise arranged to engage different types of first connector components 1080b. By way of example, first connector component 1080b may differ depending upon the configuration of compartment insert 1050, and first connector component 1082b may be substantially universal and be configured to engage any suitable first connector component 1080b. It should be appreciated that first connector components 1080b, 1082b may, in some configurations, additionally provide electrical and/or network connections.

Optional second connector components 1080c, 1082d are configured to engage to provide additional mechanical stability for compartment insert 1050 when compartment insert 1050 is inserted within compartment 1002. Optional electrical connector components 1080d, 1082d are configured to engage to provide an electrical connection that substantially enables compartment 1002 to provide power to compartment insert 1050. Optional network connector components 1080e, 1082e are configured to engage to provide a network connection that substantially enables compartment 1002 to provide compartment insert 1050 with communications capabilities, e.g., to enable compartment insert 1050 to substantially communicate with the vehicle in which compartment 1002 is located and/or to enable compartment insert 1050 to communicate on a network such as a cellular network or a 3G/4G/5G network. That is, optional network connector components 1080e, 1082e enable data transmission with respect to compartment insert 1050.

A connector cover 1084 may be arranged such that, when coupled to compartment insert 1050 and compartment 1002, second connector components 1080c, 1082c as well as optional electrical connector components 1080d, 1082d and optional network connector components 1080e, 1082e, are effectively covered and, hence, protected. Connector cover 1084 may be coupled to or otherwise attached to compartment insert 1050 and compartment 1002 either substantially directly or through the use of one or more additional mechanisms, e.g., at least one screw and/or bolt.

Optional second connector component 1080c, optional electrical connector component 1080d, and optional network connector component 1080e may be, in one embodiment, part of a single connector mounted on or integrated int compartment insert 1050. Similarly, optional second connector component 1082c, optional electrical connector component 1082d, and optional network connector component 1082e may also be part of a single connector on insert interface 1076. It should be appreciated that insert interface may generally include optional second connector component 1082c, optional electrical connector component 1082d, and optional network connector component 1082e such that insert interface 1076 may interface with substantially any suitable compartment insert 1050 when whether compartment insert 1050 includes any of, or none of, optional second connector component 1080c, optional electrical connector component 1080d, and/or optional network connector component 1080e.

Although only a few embodiments have been described in this disclosure, it should be understood that the disclosure may be embodied in many other specific forms without departing from the spirit or the scope of the present disclosure. By way of example, although power has been described as being provided to compartment inserts which utilize power by an autonomous vehicle, each compartment insert may instead have an onboard power source. That is, a compartment insert may be arranged to provide its own power such that the compartment insert is not provided with power from an autonomous vehicle. In one embodiment, a compartment insert may include a battery that is arranged to provide power for the compartment insert. In another embodiment, a compartment insert may be powered by a battery, with backup power provided by an autonomous vehicle if the battery runs out of power.

While a compartment of a vehicle has generally been described as including a communications connection, a power connection, a mechanical coupling, and an installation detection interface, it should be appreciated that a compartment of a vehicle may include other connections, couplings, and/or interfaces. For example, a compartment may include an exhaust port that allows exhaust from a compartment insert to be removed from the compartment, and/or a drainage port that enables fluids generated by a compartment insert to be drained out of the compartment. Such an exhaust port may be part of an interface arrangement such as an insert or compartment interface.

In one embodiment, a base plate or an adapter plate may be provided as an intermediate interface between a compartment insert and an insert interface of a compartment. By way of example, when two or more compartment inserts are to be inserted into a single compartment on a vehicle, a base plate or an adapter plate may be configured to enable mechanical, electrical, and/or communications connections to effectively be made between the compartment inserts and the insert interface of the compartment.

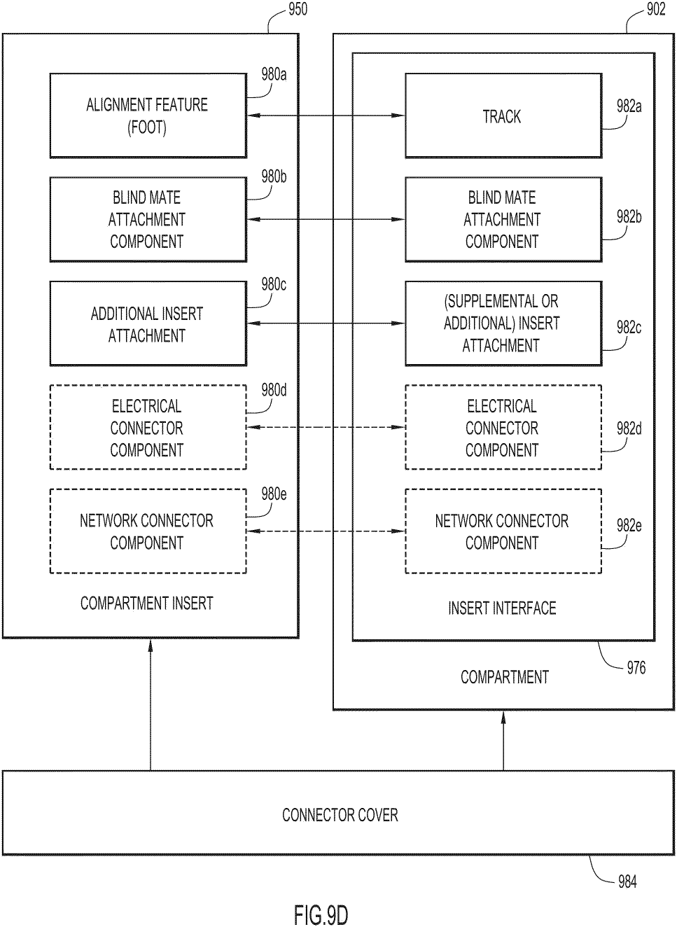

Reference is now made to FIG. 11. FIG. 11 illustrates an installation arrangement 1100 by which a person may install a compartment insert into a compartment of a vehicle, according to an example embodiment. The installation arrangement 1100 includes a lift table cart 1110 on which a compartment insert 1120 (potentially containing various items) may rest prior to being loaded, by an installer person 1122, into a vehicle via a ramp 1130 or other suitable device. The vehicle is shown at reference numeral 1140 and includes a vehicle body 1142, a compartment 1144 and a vehicle compartment interface 1146.

As shown at 1150, the compartment insert 1120 may initially sit on the lift table cart 1110 that can be moved into position near the portion of the vehicle 1140 that provides access to the compartment 1144. The lift table cart 1110 may have a height that is tall enough so that there is a downward slope of the ramp 1130 from the lift table cart 1110 to the floor of the compartment 1144. Then, the installer person 1122 can slide the compartment insert 1120, as shown by arrow 1152, off the lift table cart 1110 along the ramp 1130 downward into the compartment 1144 where the compartment insert 1120 engages the vehicle compartment interface 1146 and rests inside the compartment 1144, as shown at 1154.

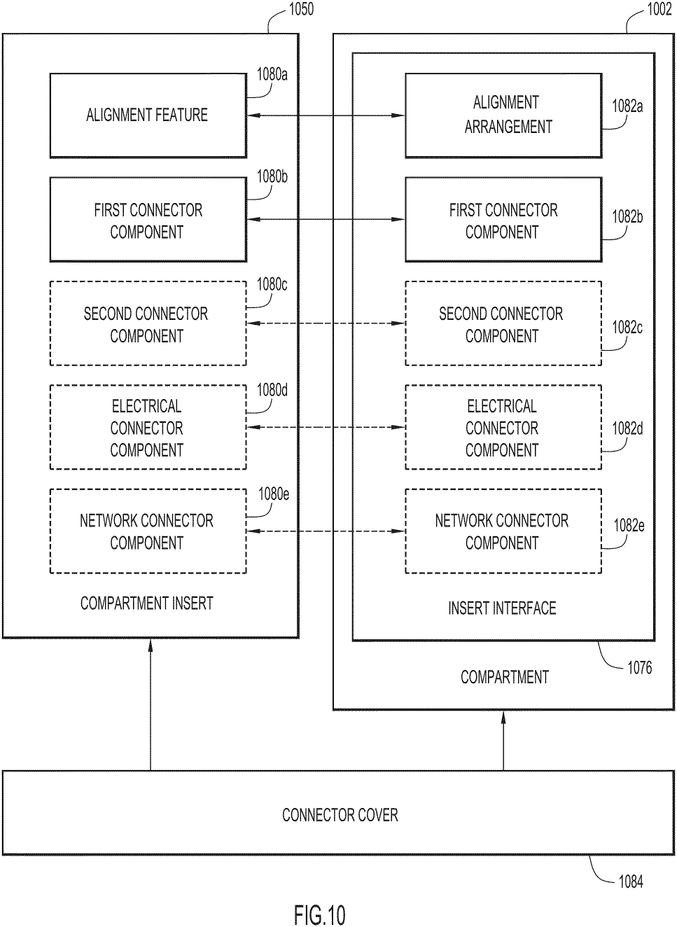

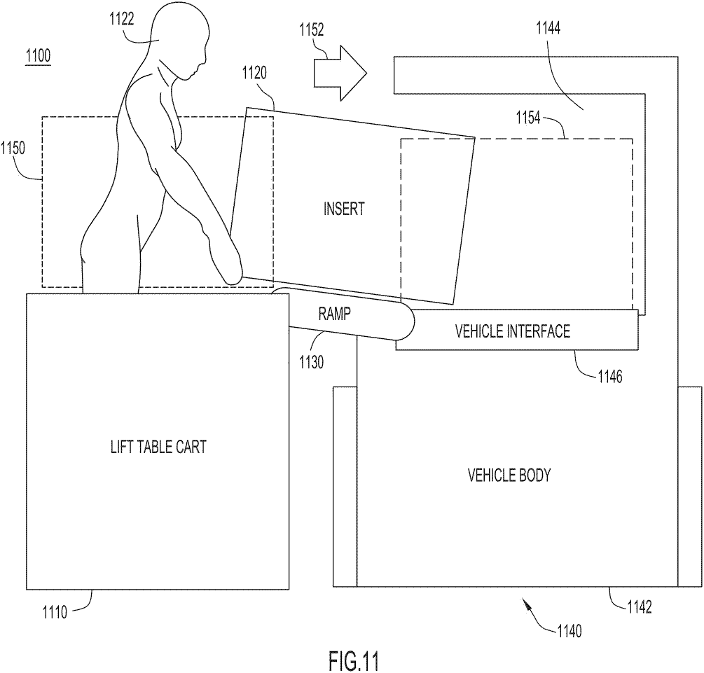

Referring now to FIGS. 12A and 12B, mechanisms and structures to facilitate the secure removable installation of a compartment insert into a compartment is now described, according to an example embodiment. FIG. 12A is a front perspective view of a compartment insert 1200 installed into a compartment interface 1210 that is mounted to a floor of a compartment of a vehicle. FIG. 12B shows a bottom perspective view of the compartment insert 1200 installed to the compartment interface 1210. There is a frame structure that includes first and second track members 1220A and 1220B, spaced from each other, and onto which a floor panel of a vehicle compartment (not shown in FIGS. 12A and 12B) is mounted. The compartment interface 1210 may further include one or more cross-members 1225. The compartment insert 1200 includes first and second rail members 1230A and 1230B that mate with channels in the first and second track members 1220A and 1220B, respectively.

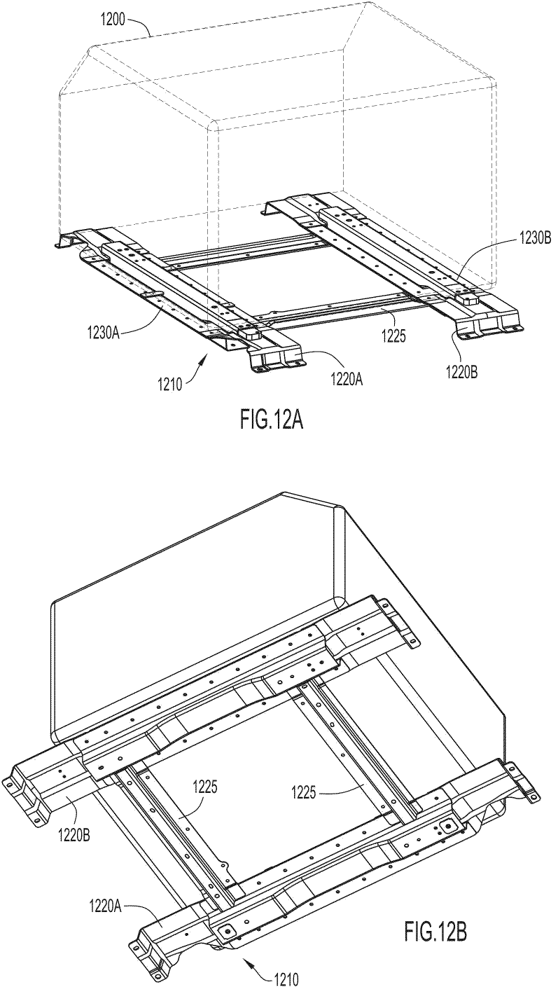

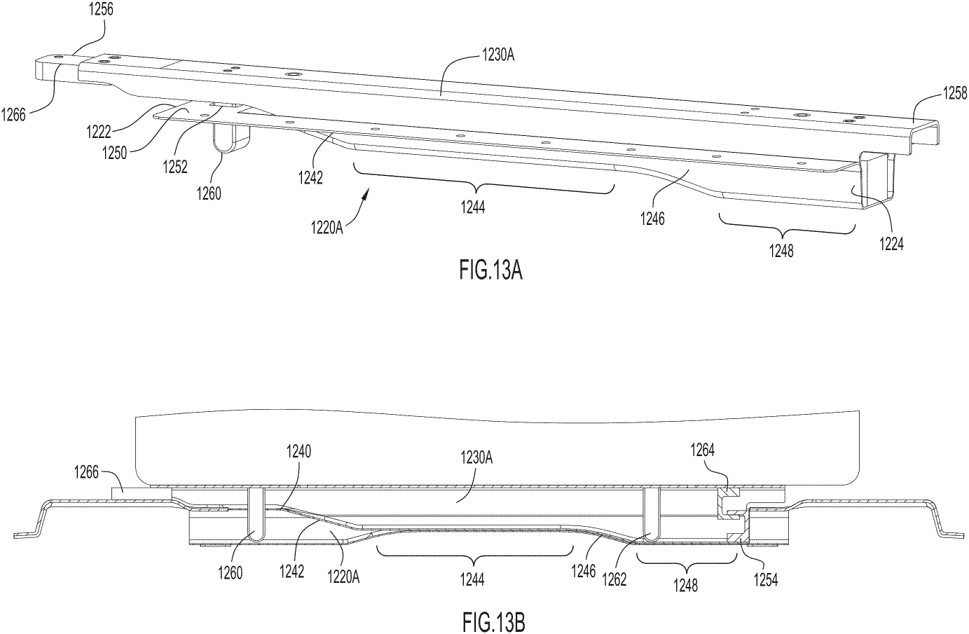

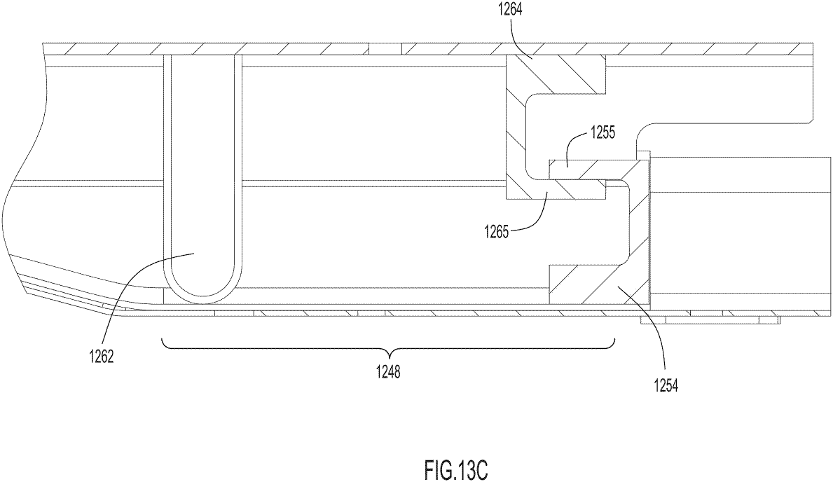

Turning now to FIGS. 13A - 13C, the track members 1220A/1220B and rail members 1230A/1230B will be described in more detail. FIG. 13A shows a perspective view of rail member 1230A installed into track member 1220A, as an example. FIG. 13B shows a side sectional view of the rail member 1230A installed into track member 1220A. FIG. 13C is an enlarged side sectional view of a rear portion of the rail member 1230A installed in the track member 1220A.

The track member 1220A has a front end 1222 and a rear end 1224, and includes a channel 1240 that has different depths along portions of its length. Specifically, the channel 1240 has a first sloped surface 1242 that extends to a first length portion 1244 of a first depth and a second sloped surface 1246 that extends to a second length portion 1248 that has a second depth. The track member 1220A further includes flat surface 1250 at the front end 1222 that includes a hole or slot (drop-in gap) 1252. At the rear end of the track member 1220A there is a latch clamp member 1254.

The rail member 1230A comprises an elongated body that includes a front end 1256, a rear end 1258, a front foot 1260 and a rear foot 1262. The front foot 1260 is configured to drop into the slot or hole 1252 of the track member 1220A. The front foot 1260 may be sized so as to float (not make contact with the bottom of the track member 1220A). The rear foot 1262 is configured to rest on the bottom of the channel 1240 in the second length portion 1248. The rail member 1230A further includes a latch clamp member 1264 that is configured to releasably engage with the latch clamp member 1254 of the track member 1220A. When the latch clamp member 1264 of the rail member 1230A is engaged with the latch clamp member 1254 of the track member 1220A, the rail member 1230A is secured within the track member 1220A, such that with a pair of mating track members and rail members, as depicted in FIGS. 12A and 12B, the compartment insert 1200 can be releasably secured into a compartment of a vehicle.

As best shown in FIG. 13C, the latch clamp member 1254 and the latch clamp member 1264 may have a generally “C” shape such that a mating surface 1255 of latch clamp member 1254 engages on top of a mating surface 1265 of latch clamp member 1264. The engagement between the latch clamp member 1254 and the latch clamp member 1264 may be facilitated by friction force, a lip on one or both of the mating surfaces 1255 and 1265 of latch clamp members 1254 and 1264, respectively, an inherent compressible nature of the material used for the latch clamp members 1254 and 1264, such as a sheet metal, etc.

At the front end 1256 of the rail member 1230A is a front mount member 1266. The front mount member 1266 may comprise a rounded extension to the front end 1256 of the rail member 1230A, and includes a hole through which a screw or bolt may be inserted that also passes through a surface of a foot of the track member 1220A.

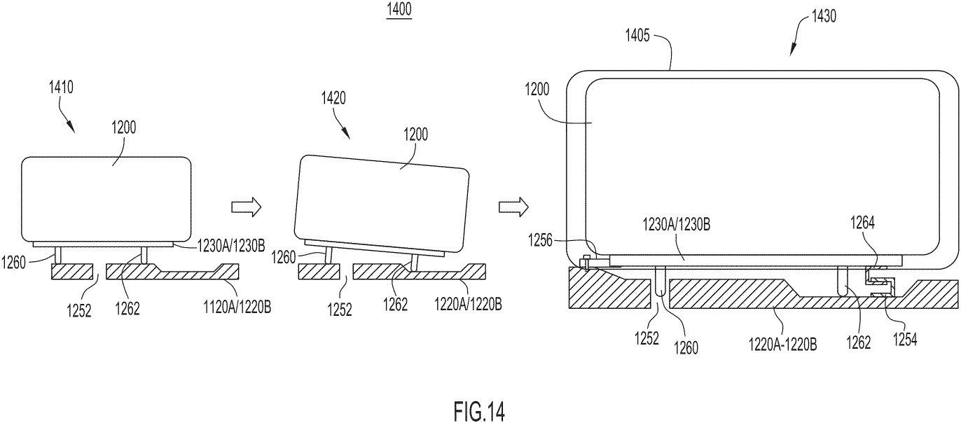

Reference is now made to FIG. 14. FIG. 14 graphically illustrates a process 1400 of installing the compartment insert 1200 (having the structural features depicted in FIGS. 12A, 12B, and 13A - 13C) into a compartment 1405 of a vehicle. At the stage 1410, the compartment insert 1200 has been moved and aligned so that the front foot 1260 and the rear foot 1262 of the rail members 1230A and 1230B are resting on the track members 1220A and 1220B, respectively. The detailed structures of the rail members 1230A/1230B and track members 1220A/1220B are not shown in FIG. 14, for simplicity.

At stage 1420, the compartment insert 1200 has been moved further onto the track members 1230A/1230B. Eventually, as the compartment insert 1200 is moved further, the rear foot 1262 of the rail members 1230A and 1230B eventually slides into position at the rear of the track members 1220A and 1220B and the latch clamp members 1254 and 1264 are in place to begin engagement. As the front foot 1260 drops into the hole or slot 1252, mating contact is made between the mating surfaces 1255 and 1265 of latch clamp members 1254 and 1264, respectively. This is shown at stage 1430. The rear foot 1262 is sized such that the front mount member 1266 is suspended above the complementary mating surface of track member 1220A/1220B. From here, a screw is torqued down through the hole in front mount member 1266 into track member 1220A/1220B, mating them together. This applies a preload to the latch clamp mating surfaces 1255 and 1265, where rear foot 1262 acts as a fulcrum. The significance of this is that the latch clamp member 1254 on track members 1220A/1220B can exert a large downward force to secure the compartment insert 1120 but does not require the installer person 1122 (FIG. 11) to exert a large force to overcome the sliding friction that would otherwise result from directly sliding mating surfaces 1255 and 1265 over each other. Dropping the front foot 1260 through the slot 1252 enables the latch clamp member 1264 to pivot about the rear foot 1262 and engage latch clamp member 1254 with minimal friction.

An insert interface in a compartment has generally been described as being formed on at least one surface of the compartment. For instance, an insert interface may be substantially integrally formed on a floor surface of a compartment. In one embodiment, an interface insert may be an adapter plate that may be positioned in a compartment of a vehicle in order to substantially adapt the compartment to receive and to substantially engage compartment inserts. When the insert interface is an adapter plate, the adapter plate may include, but is not limited to including, a power connection which enables the adapter plate to draw power from the vehicle and/or mechanical connections which are configured to enable the adapter plate to be held in a desired position within the compartment.

When no specific compartment insert is to be inserted within a compartment of a vehicle, in order to substantially prevent components of an insert interface from being exposed, a plate may be inserted in lieu of a compartment insert. Such a plate may effectively engage with a blind mate attachment and/or an additional inset attachment of the insert interface, and a connector cover may be used in conjunction with the plate to essentially restrict access to the additional insert attachment, an electrical connector component, and/or a network connector component. In one embodiment, a particular compartment insert may be a substantially default compartment insert when no specific compartment insert is requested. For example, a grocery insert may be a default compartment insert that is provided in a compartment absent any specific request for a different compartment insert.

An autonomous vehicle has generally been described as a land vehicle, or a vehicle that is arranged to be propelled or conveyed on land. It should be appreciated that in some embodiments, an autonomous vehicle may be configured for water travel, hover travel, and or/air travel without departing from the spirit or the scope of the present disclosure.

The embodiments may be implemented as hardware, firmware, and/or software logic embodied in a tangible, i.e., non-transitory, medium that, when executed, is operable to perform the various methods and processes described above. That is, the logic may be embodied as physical arrangements, modules, or components. For example, the systems of an autonomous vehicle, as described above with respect to FIG. 3, may include hardware, firmware, and/or software embodied on a tangible medium. A tangible medium may be substantially any computer-readable medium that is capable of storing logic or computer program code which may be executed, e.g., by a processor or an overall computing system, to perform methods and functions associated with the embodiments. Such computer-readable mediums may include, but are not limited to including, physical storage and/or memory devices. Executable logic may include, but is not limited to including, code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and transitory propagating signals.

In some aspects, the techniques described herein relate to an apparatus including: a compartment of a vehicle, the compartment including insert interface having at least one track and a compartment blind mate attachment component; and a compartment insert having at least one alignment feature configured to slide into the at least one track and a compartment insert blind mate attachment component configured to mate with the compartment blind mate attachment component to removably secure the compartment insert in the compartment of the vehicle.

In some aspects, the techniques described herein relate to an apparatus, further including a frame structure that includes first and second track members spaced apart from each other onto which a floor panel of the compartment is mounted, wherein the at least one alignment feature of the compartment insert includes first and second rail members spaced apart from each other and configured to slide into the first and second track members, respectively.

In some aspects, the techniques described herein relate to an apparatus, wherein the at least one alignment feature of the compartment insert includes a front foot member and a rear foot member on each of the first and second rail members spaced apart from each other along each of the first and second rail members.

In some aspects, the techniques described herein relate to an apparatus, wherein: each of the first and second track members includes a front end and a rear end, a channel between the front end and rear end, and a slot being positioned in each of the first and second track members towards the front end, wherein the channel includes first and second length portions, the second length portion positioned toward the rear end and being deeper than the first length portion for each of the first and second track members; and wherein when the compartment insert is installed in the compartment the rear foot member of each of the first and second rail members is configured to rest on a bottom surface of the channel in the second length portion and the front foot member is configured drop into the slot.

In some aspects, the techniques described herein relate to an apparatus, wherein the channel of each of the first and second track members has a sloping section that extends downward to the second length portion to facilitate insertion of the compartment insert into the compartment.

In some aspects, the techniques described herein relate to an apparatus, wherein the compartment blind mate attachment component and the compartment insert blind mate attachment component each includes a latch clamp that are mounted so as to releasably engage with other.

In some aspects, the techniques described herein relate to an apparatus, wherein: as the front foot member drops into the slot, the latch clamps of the compartment and the component insert, respectively, are configured to make contact with each other.

In some aspects, the techniques described herein relate to an apparatus, wherein each of the first and second rail members includes a front mount that is configured to be secured to a front mount of the first and second track members, respectively.

In some aspects, the techniques described herein relate to an apparatus, wherein the rear foot member is sized such that a front mount of the first and second rail members is suspended above complementary mating surfaces of the front mount of the first and second track members, respectively, and configured to permit a screw to be torqued down through a hole in front mount of the first and second rail members into the first and second track members, which in turn applies a preload to mating surfaces of the latch clamps of the compartment and the compartment insert, respectively, and the rear foot member acts as a fulcrum such that when the front foot member drops through the slot, the latch clamp of the compartment insert pivots about the rear foot member and engages the latch clamp of the compartment with minimal friction.

In some aspects, the techniques described herein relate to a compartment insert including: a body sized and shaped to removably install within a compartment of a vehicle; at least one alignment feature configured to slide into at least one track of the compartment of the vehicle; and a blind mate attachment component configured to mate with a blind mate attachment component of the compartment to removably secure the compartment insert in the compartment of the vehicle.

In some aspects, the techniques described herein relate to a compartment insert, wherein the at least one alignment feature includes first and second rails spaced apart from each other and configured to slide into first and second tracks, respectively, of the compartment.

In some aspects, the techniques described herein relate to a compartment insert, further including a front foot and a rear foot positioned on each of the first and second rails spaced apart from each other.

In some aspects, the techniques described herein relate to a compartment insert, wherein the first and second tracks each includes a channel having first and second length portions, the second length portion positioned toward a rear end of the first and second tracks and being deeper than the first length portion, and the channel having a sloping section that extends downward to the second length portion.

In some aspects, the techniques described herein relate to a compartment insert, further including latch clamps at a rear end of the first and second rails, and configured to mate with latch clamps at the rear end of the first and second tracks, respectively, and wherein when the compartment insert is installed in the compartment, the rear foot of each of the first and second rails is configured to rest on a bottom surface of a channel in the first and second tracks and the front foot is configured drop into a slot of the channel in the first and second tracks, and as the front foot drops into the slot, the latch clamps of the first and second rails are configured to make contact with the latch clamps of the first and second tracks, respectively.

In some aspects, the techniques described herein relate to a compartment insert, each of the first and second rails includes a front mount that is configured to be secured to a front mount of the first and second tracks, respectively.

In some aspects, the techniques described herein relate to a compartment insert, wherein the rear foot is sized such that the front mount of the first and second rails is suspended above complementary mating surfaces of the front mount of the first and second tracks, respectively, and configured to permit a screw to be torqued down through a hole in front mount of the first and second rails into the first and second tracks, which in turn applies a preload to mating surfaces of the latch clamps of the first and second rails and first and second tracks, respectively, and the rear foot acts as a fulcrum such that when the front foot drops through the slot, the latch clamp of the first and second rails pivots about the rear foot and engages the latch clamp of the compartment with minimal friction.

In some aspects, the techniques described herein relate to a compartment insert, further including an electrical connector component configured to connect to an electrical connector component of the compartment.

In some aspects, the techniques described herein relate to a method including: guiding a compartment insert into one or more track members of an insert interface of a compartment of a vehicle; and mechanically coupling the compartment insert to the insert interface of the compartment using one or more blind mate attachment members.

In some aspects, the techniques described herein relate to a method, wherein guiding include aligning one or more rail members of the compartment insert to slide into the one or more track members of the compartment.

In some aspects, the techniques described herein relate to a method, wherein mechanically coupling includes engaging a blind mate attachment component of the compartment insert on the one or more rail members with a blind mate attachment component on the one or more track members of the insert interface of the compartment.

In some aspects, the techniques described herein relate to a method, wherein guiding includes inserting at least one foot on the one or more rail members into the one or more track members.

In some aspects, the techniques described herein relate to a method, wherein guiding includes directing the at least one foot along a channel of the one or more track members that slopes downwardly for at least one length section towards a rear end of the one or more track members.

In some aspects, the techniques described herein relate to a method, further including: electrically coupling the compartment insert to the insert interface of the compartment using one or more electrical connectors. Methods and Apparatus for Supporting Compartment Inserts with Interface Arrangements in Autonomous Delivery Vehicles

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples are not to be limited to the details given herein, but may be modified within the scope of the appended claims.

What is claimed is:

1. An apparatus comprising:
a compartment of a vehicle, the compartment including insert interface having at least one track and a compartment blind mate attachment component; and
a compartment insert having at least one alignment feature configured to slide into the at least one track and a compartment insert blind mate attachment component configured to mate with the compartment blind mate attachment component to removably secure the compartment insert in the compartment of the vehicle.

2. The apparatus of claim 1, further comprising a frame structure that includes first and second track members spaced apart from each other onto which a floor panel of the compartment is mounted,
wherein the at least one alignment feature of the compartment insert includes first and second rail members spaced apart from each other and configured to slide into the first and second track members, respectively.

3. The apparatus of claim 2, wherein the at least one alignment feature of the compartment insert includes a front foot member and a rear foot member on each of the first and second rail members spaced apart from each other along each of the first and second rail members.

4. The apparatus of claim 3, wherein:
each of the first and second track members comprises a front end and a rear end, a channel between the front end and rear end, and a slot being positioned in each of the first and second track members towards the front end, wherein the channel comprises first and second length portions, the second length portion positioned toward the rear end and being deeper than the first length portion for each of the first and second track members; and
wherein when the compartment insert is installed in the compartment the rear foot member of each of the first and second rail members is configured to rest on a bottom surface of the channel in the second length portion and the front foot member is configured drop into the slot.

5. The apparatus of claim 4, wherein the channel of each of the first and second track members has a sloping section that extends downward to the second length portion to facilitate insertion of the compartment insert into the compartment.

6. The apparatus of claim 5, wherein the compartment blind mate attachment component and the compartment insert blind mate attachment component each comprises a latch clamp that are mounted so as to releasably engage with other.

7. The apparatus of claim 6, wherein:
as the front foot member drops into the slot, the latch clamps of the compartment and the component insert, respectively, are configured to make contact with each other.

8. The apparatus of claim 7, wherein each of the first and second rail members comprises a front mount that is configured to be secured to a front mount of the first and second track members, respectively.

9. The apparatus of claim 8, wherein the rear foot member is sized such that a front mount of the first and second rail members is suspended above complementary mating surfaces of the front mount of the first and second track members, respectively, and configured to permit a screw to be torqued down through a hole in front mount of the first and second rail members into the first and second track members, which in turn applies a preload to mating surfaces of the latch clamps of the compartment and the compartment insert, respectively, and the rear foot member acts as a fulcrum such that when the front foot member drops through the slot, the latch clamp of the compartment insert pivots about the rear foot member and engages the latch clamp of the compartment with minimal friction.

10. A compartment insert comprising:
a body sized and shaped to removably install within a compartment of a vehicle;
at least one alignment feature configured to slide into at least one track of the compartment of the vehicle; and
a blind mate attachment component configured to mate with a blind mate attachment component of the compartment to removably secure the compartment insert in the compartment of the vehicle.

11. The compartment insert of claim 10, wherein the at least one alignment feature includes first and second rails spaced apart from each other and configured to slide into first and second tracks, respectively, of the compartment.

12. The compartment insert of claim 11, further comprising a front foot and a rear foot positioned on each of the first and second rails spaced apart from each other.

13. The compartment insert of claim 12, wherein the first and second tracks each comprises a channel having first and second length portions, the second length portion positioned toward a rear end of the first and second tracks and being deeper than the first length portion, and the channel having a sloping section that extends downward to the second length portion.

14. The compartment insert of claim 13, further comprising latch clamps at a rear end of the first and second rails, and configured to mate with latch clamps at the rear end of the first and second tracks, respectively, and wherein when the compartment insert is installed in the compartment, the rear foot of each of the first and second rails is configured to rest on a bottom surface of a channel in the first and second tracks and the front foot is configured drop into a slot of the channel in the first and second tracks, and as the front foot drops into the slot, the latch clamps of the first and second rails are configured to make contact with the latch clamps of the first and second tracks, respectively.

15. The compartment insert of claim 14, each of the first and second rails comprises a front mount that is configured to be secured to a front mount of the first and second tracks, respectively.

16. The compartment insert of claim 15, wherein the rear foot is sized such that the front mount of the first and second rails is suspended above complementary mating surfaces of the front mount of the first and second tracks, respectively, and configured to permit a screw to be torqued down through a hole in front mount of the first and second rails into the first and second tracks, which in turn applies a preload to mating surfaces of the latch clamps of the first and second rails and first and second tracks, respectively, and the rear foot acts as a fulcrum such that when the front foot drops through the slot, the latch clamp of the first and second rails pivots about the rear foot and engages the latch clamp of the compartment with minimal friction.

17. The compartment insert of claim 10, further comprising an electrical connector component configured to connect to an electrical connector component of the compartment.

18. A method comprising:
guiding a compartment insert into one or more track members of an insert interface of a compartment of a vehicle; and
mechanically coupling the compartment insert to the insert interface of the compartment using one or more blind mate attachment members.

19. The method of claim 18, wherein guiding comprise aligning one or more rail members of the compartment insert to slide into the one or more track members of the compartment.

20. The method of claim 19, wherein mechanically coupling comprises engaging a blind mate attachment component of the compartment insert on the one or more rail members with a blind mate attachment component on the one or more track members of the insert interface of the compartment.

21. The method of claim 19, wherein guiding comprises inserting at least one foot on the one or more rail members into the one or more track members.

22. The method of claim 21, wherein guiding comprises directing the at least one foot along a channel of the one or more track members that slopes downwardly for at least one length section towards a rear end of the one or more track members.

23. The method of claim 18, further comprising:
electrically coupling the compartment insert to the insert interface of the compartment using one or more electrical connectors.
